(19) United States
(12) Patent Application Publication
(10) Pub. No.: US 2018/0001428 A1
(43) Pub. Date: Jan. 4, 2018

(54) SOUND REDUCTION DEVICE AND JOINING METHOD, AND A PART MACHINING METHOD WITH SOUND INSULATION

(71) Applicant: BÖLLHOFF VERBINDUNGSTECHNIK GmbH, Bielefeld (DE)

(72) Inventor: Torsten Draht, Schloß Holte-Stukenbrock (DE)

(21) Appl. No.: 15/543,309

(22) PCT Filed: Dec. 21, 2015
(86) PCT No.: PCT/EP2015/080869

§ 371 Date: Jul. 13, 2017

(30) Foreign Application Priority Data
Jan. 15, 2015 (DE) 10 2015 000 196.5

(51) Int. Cl. B23Q 11/00; B23Q 3/06; B21J 15/02

(52) U.S. Cl. CPC B23Q 11/0032; B21J 15/025; B23Q 3/065

(57) ABSTRACT

A sound reduction device for use in a mechanical machining method or a joining method, in particular a pulse-type joining method. The sound reduction device comprises a clamping device by means of which at least one part to be machined can be clamped at a plurality of clamping locations, as well as a plurality of engagement components which engage the part surface at a number of engagement points, in order to damp vibrations of the part. The present disclosure also describes a joining method and a machining method in combination with the sound reduction device.

### 1. TECHNICAL FIELD

The present disclosure relates to a sound reduction device for use in a mechanical processing method of a component or a joining method, in particular in a pulse-like joining method, of at least two components. Furthermore, the present disclosure relates to a joining method for joining at least a first and a second component, in particular a pulse-like joining method, in which a sound insulation and thus a reduced noise exposure is achieved by means of the sound reduction device. In addition, the present disclosure relates to a machining method for machining a component, for example a separating or milling method, in which a reduced noise exposure of the environment can be achieved by means of the sound reduction device.

### 2. BACKGROUND

Various machining methods, for example of sheet metal, are known in the industry, which can only be realized with a relatively high noise emission. Such machining methods include, for example, the sawing or generally separating of large-area sheet metal components. Furthermore, joining methods are known, such as the high-speed bolt setting according to EP 1 926 918 B2, in which also a high noise exposure for the environment occurs. This is because, for the joining of at least two parts, a bolt is fired into the part group, while the bolt striking the parts, a portion of its kinetic energy is transformed into component vibrations and thus noise for the environment. Although this joining method is applicable to various types of connections especially in the automobile construction, the high noise exposure of the environment is a significant drawback. Therefore, production units are currently surrounded with sound-proof booths with a cost-intensive effort. On the one hand, this reduces the noise exposure of the environment, but on the other hand leads to an increased space requirement and additional production costs while adhering to the noise protection conditions in the production line.

In the known machining methods and joining methods, a mechanical vibration is generated in the parts, which in turn causes the structure-borne noise to occur. The structure-borne noise, which is converted by the part into airborne sound, depends on the material used and the construction of the part(s) besides the machining or joining method used. In addition, the arrangement of the parts with respect to the surrounding medium has an influence during the joining or machining. Since the part geometry is compulsory in vehicle construction, for example, it is not possible to reduce the body noise by changing the configuration of the part. Therefore, in the vehicle industry, for example, the noise exposure is realized by a complete enclosure of machine and part to be machined. In contrast to this, in the construction industry, for example, large-area parts are used in sandwich constructions. These sandwich constructions comprise area-like constructional parts made of vibrating materials such as, for example, metal. In order to support the noise generation, noise reflection and a noise insulation behavior in constructional parts used in this way, the part is coated on one or both sides with a viscoelastic material. The structure-borne sound produced in the part is damped by the damping properties of the viscoelastic coating material. Since large-area parts can be prefabricated in the construction industry or in the construction of wagons, without the need for further mechanical or thermal loading, the processing of large-area sandwich structures is suitable. If, however, it is necessary to thermally load such sandwich structures, for example during the thermal drying of cathodically dip-coated (KTL) body parts at 180° C., the above-described viscoelastic boom coatings of these constructional parts would be thermally or chemically destroyed. Therefore, in the automobile industry, the sound-absorbing housing of production stations has hitherto been preferred.

With respect to the known prior art, it is thus the object of at least certain implementations of the present disclosure to provide a device and a method alternatively to the sound-absorbing housing of machining or production stations, by means of which a reduced noise pollution of the environment can be achieved while avoiding the sound-absorbing housing.

### 3. SUMMARY

The above problem may be solved by a sound reduction device for use in a mechanical machining method or a joining method, in particular in a pulse-like joining method, according to the independent patent claim 1, by a joining method for connecting at least a first and a second part, in particular a pulse-like joining method, according to claim 8, as well as by a machining method according to independent claim 11. Advantageous embodiments and developments of the present disclosure result from the dependent claims, the description of the detailed embodiments and the accompanying drawings.

The sound reduction device for use in a mechanical machining method or a joining method, in particular in a pulse-like joining method, has the following features: a clamping device by means of which at least one part to be machined or a plurality of parts to be connected to one another can be clamped releasably at a plurality of clamping points between components cooperating with each other so that the machining or the joining is ensured, and wherein a number of engagement points with respective engagement components is provided, by means of which the part can be engaged in at least one vibration-sensitive part portion at least on one side, so that a part vibration can be damped compared to a part vibration without the engagement components. Preferably, the at least one part or the plurality of parts can be fastened to a base by means of a number of clamping points with corresponding fastening components.

Known components of different constructions can usually be divided into different portions. An outer edge portion of the component is suitable to fasten the part or a plurality of parts to a base. Such an edge fastening is space-saving and also requires a limited constructional effort, since part regions have to be bridged not constructionally complex in order to achieve a fastening in the inner region of a part or a part stack. In addition, parts, such as supporting structures or covering sheet elements from the vehicle industry, have areal sections which are susceptible to part vibration during a joining or machining process. This means that vibrations generated by machining methods and joining methods are picked up especially by these areal portions and are converted into structure-borne sound. This structure-borne sound causes a noise pollution of the environment. According to the present disclosure, the sound reduction device provides in addition to the fastening components of the clamping point also a number of engagement points with respective engagement components. These engagement components represent mechanical, movable constructions which can be arranged in abutment in a punctual or an areal manner in selected part portions on the part by means of an engagement surface. Such an engagement of the at least one engagement component in one of the above-mentioned areal portions of the part reduces the mechanical vibration of the part and thus the structure-borne sound of this part portion. The engagement components of the engagement points preferably engage one-sided or two-sided on a part or a stack of parts in order to realize an insulation of the structure-borne sound of the part or of the stack of parts. According to different embodiments of the present disclosure, as described in more detail below, the following condition are varied in order to achieve an optimal insulation of the structure-borne sound: the number of engagement points, their arrangement, the size of the engagement point which engages or abuts the part, as well as the material of which the end part of the engagement component engaging the part consists.

According to an embodiment of the sound reduction device, the number of clamping points can be arranged in an edge area of a part, while the vibration-sensitive part area can be engaged by the engagement components with an area in the range from 100 cm² to 10 m². It has been recognized that straight component regions starting from a surface area of 100 cm² promote the formation of structure-borne sound of a part to be machined or to be joined. Therefore, it is preferred to hinder part regions with a minimum size of 100 cm² to 10 m² by the engagement of one or a plurality of engagement components in its structure-borne sound generating vibration. In this way, the noise emission of the part is reduced.

According to a further embodiment of the sound reduction device, the part can be engaged with 1 to 3 engagement components per standard area of 100 cm² of the vibration-sensitive part portion. This means that, for an areal segment of 100 cm² of the vibration-sensitive part region, preferably 1 to 3 engagement components are provided to engage the part surface and to reduce thereby vibrations of the part. Preferably, the 1 to 3 engagement components are arbitrarily distributed in the areal segment having a size of 100 cm². According to one embodiment, two or three engagement components are arranged linearly side by side and equally spaced in the vibration-sensitive part portion of the above-stated size. It is also preferred to provide more than three engagement components in the specified areal portion.

According to a further embodiment, the engagement component has an engagement surface engaging the part which is made of metal or plastic or a hybrid consisting of metal core and plastic cover or bitumen or silicone. The engagement components preferably abutting on the part surface repress the vibrations being present in the part and thus the structure-borne sound. Depending on the part configuration, it is preferred to provide the engagement surfaces of the engagement component engaging the component from different materials. Depending on the type of material, by means of these material-specific engagement surfaces vibrations of the component can be selectively dampened.

According to a further embodiment of the sound reduction device, at least one engagement component comprises a sound damping layer, which can be pressed on one side onto the at least one part in at least a part portion such that a sound energy emitted by the part can be repressed. Correspondingly, the engagement component is equipped not only with a punctual engagement surface but with a larger sound damping layer. This sound damping layer preferably has a size of >1 cm² and can be adapted to the size of the vibration-sensitive part portion. The more surface of the vibration-sensitive part portion is covered by one or more sound damping layers, the more effective the structure-borne sound produced by the part can be damped. It is understood that the above-mentioned engagement components of the engagement points in their different embodiments are only temporarily placed on the component surface, on one or both sides, or pressed onto them, respectively.

According to a further embodiment of the sound reduction device, the above-mentioned sound damping layer consists of a material which is characterized by a loss or dissipation factor din the range of 0.05≦d≦1. The loss factor d describes the repressing capacity of the material of the sound damping layer for a vibration in a part which causes a structure-borne sound. This loss factor d is determinable on the basis of the DIN EN ISO 6721-3, which is referred to hereby. In DIN EN ISO 6721-3 a test device, the configuration of a sample body, the performance of a measurement, the evaluation and display of the measurement results as well as the calculation of the bending loss factor d are described. From this description, it is possible to assign the particular loss factor d to certain preferred configurations.

According to a further embodiment of the sound reduction device, it is used in combination with a pulse-like joining method, with a high-speed bolt setting, by means of which the parts to be connected are fixed and a sound energy emitted by the parts to be joined is repressed. Such a high-speed bolt setting is described in the European patent EP 1 926 918 B2, which is referred to for the technical details of this method.

The present disclosure also comprises a joining method for joining at least a first and a second part, in particular a pulse-like joining method, comprising the following steps: releasably fixing the at least two parts by means of a clamping device with which a plurality of parts to be connected to each other are clamped at a plurality of clamping points between fastening components cooperating with each other, respectively, wherein the plurality of clamping points fixes the plurality of parts to a base so that a joining of the parts is ensured, and at least one-sided engaging of at least one engagement component in at least a vibration-sensitive part portion of the at least two parts at least at an engagement point so that part vibration can be damped compared to a part vibration without the engagement component, and joining the at least two parts.

According to the above joining method, first of all the at least two parts are fixed temporarily and releasably to the base by means of the fastening components of the clamping device. These fastening components correspond to the above-described fastening components of the clamping points of the sound reduction device. After the at least two components have been releasably fixed, at least one engagement component is moved in such a way that it engages in a vibration-sensitive part portion of the at least two parts. This engagement of the engagement component realizes a repressing of possible vibrations of the at least two parts so that occurring structure-borne sound is reduced during the joining of the at least two parts. The here mentioned engagement components correspond to the above-described engagement components of the sound reduction device. Subsequently, the at least two parts are joined, wherein different joining methods are used. These joining methods include the group of pulse-like joining methods such as, for example, the high-speed bolt setting (see above) and the impulse punch riveting. Further joining methods are the punch riveting with semi-hollow punch rivet or solid punch rivet, the blind riveting with pulling off of the tension bolt, the clinching and the inserting of a flow-form-screw. In contrast to the introduction of the flow-form-screw, it is thus preferred to use pulse-like joining methods in which the joining element is inserted almost without any rotation into the at least two parts. Furthermore, joining methods are used in which a punch occurs and/or in which a rotation of the joining element is also provided.

According to the disclosure, in the joining method, the number of clamping points is arranged in an edge portion of a part, whereas the engagement components of the engagement points engage in at least an areal portion in the size from 100 cm² to 10 m². Furthermore, the joining method comprises the following step: applying at least one sound damping layer to the part surface by means of the at least one engagement component such that an amount of emitted sound energy during the joining method is less than a sound energy amount without using the sound damping layer. With regard to the design of the sound damping layer, reference is made to the above.

The present disclosure further comprises a machining method for at least one part, comprising the following steps: releasably fixing the at least one part by means of a clamping device by means of which the at least one part is clamped at a plurality of clamping points between fastening components cooperating with each other, wherein the plurality of clamping points fasten the at least one part to a basis so that a machining of the at least one part is ensured, and at least one-sided engagement of at least one engagement component in at least one vibration-sensitive part portion of the at least one part at at least one engagement point, so that a part vibration can be dampened compared to a part vibration without the engagement component, and machining the at least one part.

### 4. BRIEF DESCRIPTION OF THE ACCOMPANYING DRAWINGS

Representative embodiments of the present disclosure will be explained in more detail with reference to the accompanying drawings. It shows:

FIG. 1 is a schematic representation of an embodiment of a joining method with a sound reduction device,

FIG. 2 is a further schematic representation of a part arrangement, and

FIG. 3 is a flow chart of an embodiment of the joining method and the machining method.

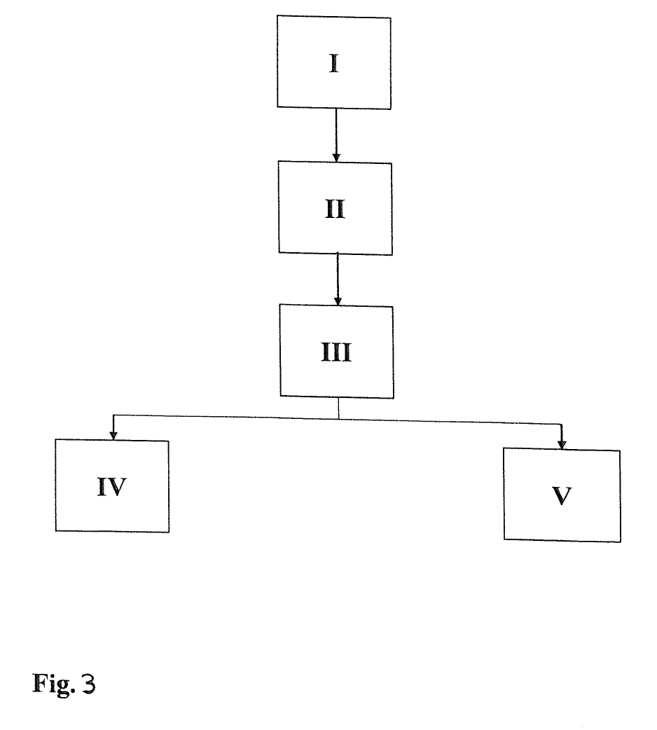

### 5. DETAILED DESCRIPTION

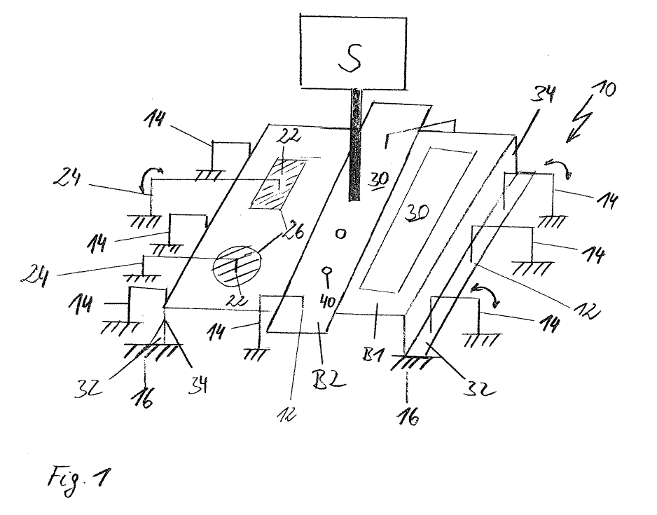

Referring to FIG. 1, structure, function and use of a sound reduction device are described using the example of a joining method, preferably a pulse-like joining method. The sound reduction device can be used in combination with machining methods in the same way as in combination with joining methods. As soon as the machining method or joining method, such as sawing, punching, bending, bolt setting, generates vibrations in the machined part or in a plurality of parts, these are perceived as structure-borne sound. Structure-borne sound is transmitted to the environment as an airborne sound or noise. In addition, it is possible that structure-borne sound is transmitted between adjoining parts. In order to reduce the noise exposure of the environment, at least some implementations of the present invention repress or damp the structure-borne sound.

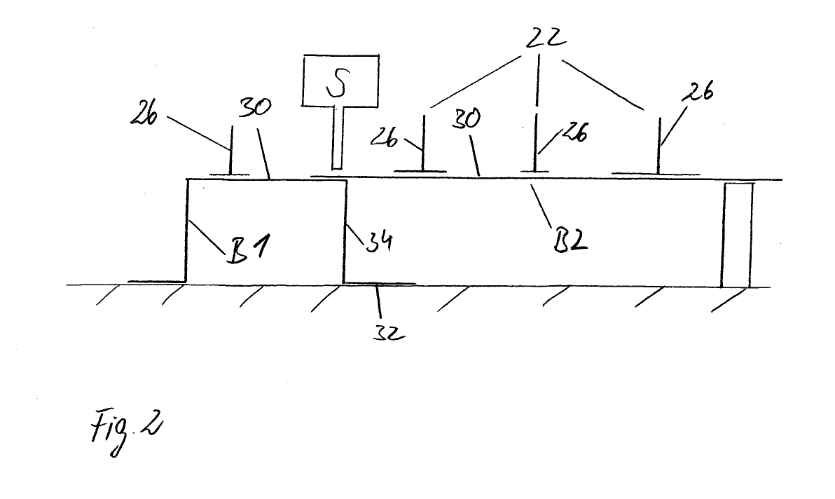

FIG. 2 shows a schematic representation of two exemplary parts B1 and B2. The part B1 is a profile, here a hat profile. It is also conceivable that it is a T-profile, an L-profile, a tube profile or an H-profile. Such profiles have partially extended areal portions which are susceptible to vibration excitation and thus to the generation of structure-borne sound. Such portions are referred to as vibration-sensitive part portions 30. They are mostly larger than a flange portion 32 or a web portion 34, which often has vibration-repressive clamping points 12. Due to this characterization, vibration-sensitive part portions 30 preferably have a size G of 100 cm²≦G≦10 m².

Referring again to FIG. 2, the combination of the profile part B1 with, for example, a cover plate or, in general, an areal part B2 is here shown schematically. Due to their areal size, both parts B1 and B2 have vibration-sensitive part portions, which represent the preferred sources of structure-borne sound. It has been recognized that a part vibration and thus structure-borne sound can be dampened by a punctual as well as by an areal engaging, preferably a one-sided or a two-sided engaging, on such vibration-sensitive part portions 30. In this context, preferably a number of engagement points 22 per part portion 30 and/or a size of the engagement component 24, 26 abutting the part surface and/or a material of the engagement component 24, 26 abutting the part B1, B2 are selectively modified to be able to set the repressing behavior depending on the parts B1, B2. This is indicated in FIG. 2 in relation to the different vibration-sensitive part portions 30 of parts B1 and B2.

Preferably, and with respect to the vibration-sensitive part portion 30 having a unit of area of 100 cm² one to three, preferably one or two, engagement components 24 are arranged engaging the part surface. These engagement components 24 are preferably equally distributed over the unit of area and are arranged regularly. Accordingly, three to nine engagement components 24 preferably engage a vibration-sensitive part portion 30 of a size of approximately 300 cm², since it consists of three units of area of 100 cm² each.

FIG. 1 schematically shows an arrangement for a pulse-like joining method of the two parts B1 and B2. A bolt-setting method according to EP 1 926 918 B2 is preferably used as a pulse-like joining method. For the various method arrangements of bolt setting, reference is made to the said European patent, which is incorporated into the description hereby.

According to FIG. 1, the part B1 is a profile part with the flange 32. A plurality of clamping points 12 is provided on the flange 32, at which the part 1 can be releasably fixed to a base 16, for example a spanning device or a supporting structure. To this end, a movable clamping device 10 is arranged in the vicinity of each clamping point 12. This consists, for example, of at least two fastening components 14, 16, which are movable relative to each other. In this case, the fastening components 14, 16, which can be moved relative to each other, are a clamping arm or a clamping mechanism 14, which can be pivoted according to FIG. 1, and the base 16, which forms a fixed support with respect to the parts B1, B2. The pivoting movement of the clamping arm 14 serves for the movement between a clamping position, in which the part or parts 1, 2 are fixed between the clamping arm 14 and the base 16, and a release position in which the part(s) 1, 2 is/are no longer fixed. It is understood that the clamping mechanism 14 may also perform alternative motions to move between release position and clamping position. Optionally, a constructive support element is arranged below or adjacent to a joining portion of the parts B1 and B2 (in FIG. 1 covered by the parts B1 and B2 and therefore not shown), so that the parts B1 and B2 are not overloaded by the joining process.

Although the components B1 and B2 are temporarily fixed at the clamping points and optionally have a mechanical support (not shown) adjacent to or in the joining portion, these clamping points 12 are not sufficient to prevent the structure-borne sound of the parts B1, B2 during the joining process by a setting device S sufficiently. As can be seen from FIG. 1, the bolts 40 are placed within the vibration-sensitive portions 30 or in portions adjacent to these vibration-sensitive part portions 30. This supports the occurrence of structure-borne sound and the associated noise pollution or exposure.

With regard to a reduced noise emission during the joining and machining of the parts B1, B2, it is preferred to arrange a joining zone as close as possible to the clamping points 12, wherein the joining zone is the region into which the bolts 40 are set. In this way, a part vibration can already be reduced by the clamping points 12.

It is also preferred to arrange one to ten clamping points per standard length of 1 m of the part B1; B2 to releasably fasten the part B1; B2, for example, in the flange portion.

According to FIG. 1, the areal portion between the flanges 32 and webs 34 of the part B1 represents a vibration-sensitive part portion 30. This is indicated on the right-hand side of FIG. 1, although it also extends below the part B2 and on the left-hand side of FIG. 1. In addition, the part B2 also forms a vibration-sensitive part portion 30. In order to reduce vibrations in these vibration-sensitive part portions 30, it is first preferred to provide additional clamping points 12 (not shown) especially in these portions 30.

According to a further embodiment, the sound reduction device comprises a number of engagement points 22 arranged in or adjacent to or next to the vibration-sensitive part portions 30. The engagement points 22 are preferably positioned in the vibration-sensitive part portions 30. At the engagement points 22 the component surface is engaged by mechanical engagement components 24. This engagement of the engagement component 24 takes place at the part B1; B2 preferably on one side or on both sides. By the engaging of the engagement component 24, component vibrations are damped or reduced.

In order to achieve an optimal damping result by this engagement, the engagement area of the engagement component 24 engaging the part B1; B2 is made of metal or plastic or a hybrid consisting of metal core and plastic cover or bitumen or silicone or rubber or of damping cardboard.

According to a further embodiment, the engagement surfaces of the engagement component 24 are formed as areal sound damping layers 26. These sound damping layers 26 are preferably adapted in size to the vibration-sensitive part portion 30. According to different embodiments of the disclosure their size varies between 1 cm² and 2 m², preferably between 4 cm² and 0.4 m².

In addition to the number of engagement components, which comprise one to three engagement components 24 or engagement points 22 per unit of area of 100 cm² in the vibration-sensitive part portion 30, the shape of the sound damping layer 26 can also be adjusted. Here it is preferred to adapt the shape of the sound damping layer 26 to the shape of the part or to form the sound damping layer 26 as large as possible.

According to a further embodiment, the engagement surface of the engagement component 24 and the sound damping layer 26 are made of a viscoelastic material. This viscoelastic material is characterized by the loss factor d in the range of 0.05≦d≦1. The loss factor d describes the damping behavior of the contact area or sound damping layer 26, which is applied as a coating to the part B1; B2. The loss factor d is a measure of the proportion of kinetic energy introduced into the parts B1, B2, which is converted into heat within the material. Therefore the loss factor d is a material parameter, which can be taken from tables. In addition, the loss factor d is defined in DIN EN ISO 6721-3, which is hereby incorporated by reference in order to determine the loss factor. The structure-borne sound damping described by the loss factor d describes the conversion of the oscillation energy of the part B1; B2 by internal friction of the material of the sound damping layer 26 or the engagement surface of the engagement component 24 into heat.

While on the one hand, the material used for the damping layer 26 can be characterized by the loss factor d, the following materials are on the other hand preferred as damping layer 26 according to the disclosure: plastics, hybrids consisting of metal core and plastic cover, bitumen, silicone, rubber and damping cardboard.

During a joining method for connecting at least a first part and a second part B1, B2 or during a machining process of one or more parts B1, B2, a releasable fixing of the part or parts B1; B2 takes place in step I first. This fixing is realized by the clamping device 10 discussed above with the plurality of fastening components 14, 16 at the clamping points 12. Due to the present part geometry of the parts B1, B2, the vibration-sensitive part portions 30 are recognizable on account of their size (see above). Therefore, in the next step II, an at least one-sided engagement of the engagement surface of the engagement component 24 occurs adjacent to, in or next to these vibration-sensitive part portions 30. As soon as the engagement components 24 engage the parts B1, B2 by means of their engagement surfaces or by means of sound damping layers 26, an additional damping of possibly occurring vibrations of the components and thus a damping of the structure-borne sound is provided. Therefore, the joining of the at least two parts B1, B2 takes place in step IV or the machining of the at least one part B1 in step V.

Certain embodiments or components or features of components have been noted herein as being “preferred” and such indications are to be understood as relating to a preference of the applicant at the time this application was filed. Such embodiments, components or features noted as being “preferred” are not required for implementation of the inventions disclosed herein unless otherwise indicated as being required, or unless specifically included within the claims that follow.

1. A sound reduction device in combination with a setting device for use in a joining method, in particular in a pulse-like joining method or a high-speed bolt setting method, comprising the following features:
a. a clamping device with which at least one part to be machined or a plurality of parts to be connected to each other can be clamped releasably at a plurality of clamping points between fastening components cooperating with each other, respectively,
b. so that the joining is ensured, and wherein
c. a number of engagement points with respective engagement components are provided by means of which the part is engageable at least on one side in at least a vibration-sensitive part portion so that a part vibration can be damped compared to a part vibration without engagement components.

2. The sound-reduction device according to claim 1, in which the number of clamping points can be arranged in an edge portion of a part, while the vibration-sensitive part portion with an area in the range from 100 cm² to 10 m² can be engaged by the engagement components.

3. The sound reduction device according to 2, by means of which the part can be engaged with 1 to 3 engagement components per standard area of 100 cm² of the vibration-sensitive part portions.

4. The sound reduction device according to claim 3, the engagement component of which has an engagement surface on the part consisting of metal or plastic or a hybrid consisting of metal core and plastic cover or bitumen or silicone.

5. The sound reduction device according to claim 4, in which at least one engagement component has a sound damping layer which can be pressed against the at least one part on one side in at least a part portion so that a sound energy emitted by the part can be damped.

6. The sound reduction device according to claim 5, in which the at least one sound damping layer is made of a material having a loss factor d in the range of 0.05≦d≦1.

7. (canceled)

8. A joining method using a setting device for joining at least a first part and a second part, in particular a pulse-like joining method, comprising the following steps:
a. releasably fixing the at least two parts by means of a clamping device by means of which a plurality of parts to be connected are clamped at a plurality of clamping points between fastening components cooperating with each other, respectively, wherein the plurality of clamping points fastens the plurality of parts to a base, so that the joining of the parts is ensured, and
b. at least one-sided engaging of at least one engagement component in at least a vibration-sensitive part portion of the at least two parts at at least one engagement point so that a part vibration can be damped compared to a part vibration without the engagement component, and
c. joining the at least two parts by means of the setting device.

9. The joining method according to claim 8, in which the number of clamping points is arranged in an edge portion of a part while the engagement components of the engagement points are arranged in at least one areal portion of a size of 100 cm² to 10 m².

10. The joining method according to claim 8, with the further step: applying at least one sound damping layer on the part surface with the at least one engagement component, so that an amount of an emitted sound energy during the joining method is lower than an amount of sound energy without use of the sound damping layer.

11. (canceled)

12. (canceled)

13. (canceled)

14. The joining method according to claim 9, with the further step: applying at least one sound damping layer on the part surface with the at least one engagement component, so that an amount of an emitted sound energy during the joining method is lower than an amount of sound energy without use of the sound damping layer.

15. The sound reduction device according to 1, by means of which the part can be engaged with 1 to 3 engagement components per standard area of 100 cm² of the vibration-sensitive part portions.

16. The sound reduction device according to claim 1, the engagement component of which has an engagement surface on the part consisting of metal or plastic or a hybrid consisting of metal core and plastic cover or bitumen or silicone.

17. The sound reduction device according to claim 2, the engagement component of which has an engagement surface on the part consisting of metal or plastic or a hybrid consisting of metal core and plastic cover or bitumen or silicone.

18. The sound reduction device according to claim 1, in which at least one engagement component has a sound damping layer which can be pressed against the at least one part on one side in at least a part portion so that a sound energy emitted by the part can be damped.

19. The sound reduction device according to claim 2, in which at least one engagement component has a sound damping layer which can be pressed against the at least one part on one side in at least a part portion so that a sound energy emitted by the part can be damped.

20. The sound reduction device according to claim 3, in which at least one engagement component has a sound damping layer which can be pressed against the at least one part on one side in at least a part portion so that a sound energy emitted by the part can be damped.

21. The sound reduction device according to claim 18, in which the at least one sound damping layer is made of a material having a loss factor d in the range of 0.05≦d≦1.

22. The sound reduction device according to claim 19, in which the at least one sound damping layer is made of a material having a loss factor d in the range of 0.05≦d≦1.

23. The sound reduction device according to claim 20, in which the at least one sound damping layer is made of a material having a loss factor d in the range of 0.05≦d≦1.

24. The joining method according to claim 8, wherein the joining by means of the setting device includes setting of a semi-hollow punch rivet or setting of a solid punch rivet.
